(19) United States
(12) Patent Application Publication
(10) Pub. No.: US 2004/0107077 A1
(43) Pub. Date: Jun. 3, 2004

(54) Models for predicting perception of an item of interest

(76) Inventors: Moitreyee Sinha, Clifton Park, NY (US); Pratima Rangarajan, Clifton Park, NY (US); Martha M. Gardner, Niskayuna, NY (US); Vicki Watkins, Alplaus, NY (US); Deniz Senturk, Schenectady, NY (US)

Correspondence Address: CANTOR COLBURN, LLP, 55 GRIFFIN ROAD SOUTH, BLOOMFIELD, CT, 06002

(21) Appl. No.: 10/307,547

(22) Filed: Nov. 30, 2002

(51) Int. Cl. G06F 17/10

(52) U.S. Cl. 703/2

(57) ABSTRACT

Statistical models for quantifying and predicting human perception of scratches on automotive components are disclosed. Such models may be created by utilizing quantitative two-step moving scale surveys. Such surveys employ a continuous scale to model human perception and allow response bias and measurement error in survey data to be evaluated. Once survey data is collected, relationships between the visual perception of the scratches and the measurable optical properties associated with the scratches can be determined. Additionally, relationships between the visual perception of the scratches and the actual physical scratch dimensions can be determined. Thereafter, models for predicting the human perception of such scratches can be created therefrom. Since these models predict the results of such surveys, the need for repeatedly collecting survey data is eliminated. These models may also be used for predicting human perception of other items of interest. Furthermore, the two-step moving scale surveys may be used in various kinds of surveys about any items of interest.

### FIELD OF THE INVENTION

This invention relates generally to models created from quantitative two-step moving scale surveys. More specifically, this invention relates to models for predicting survey respondents' perception of an item of interest, particularly visual perception of surface irregularities such as scratches on automotive exterior components, wherein two-step moving scale surveys are utilized to evaluate response bias and measurement error in the survey data upon which the models are built.

This invention also relates generally to systems and methods for evaluating response bias and measurement error in surveys. More specifically, this invention relates to utilizing quantitative two-step moving scale systems and methods to evaluate response bias and measurement error in customer surveys about human perception of an item of interest, particularly visual perception of surface irregularities such as scratches on automotive exterior components.

### BACKGROUND OF THE INVENTION

As automotive manufacturers move away from metallic substrates for the exterior components, aesthetic considerations replace rust and/or corrosion resistance as the primary concern for a scratched area. Scratches on thermoplastics and painted systems, such as those used for automotive exterior components, cause distinct visual appearances. This can involve changes in surface topography, color, gloss and any other optical attributes that result in a visual contrast. Although this is an important consideration in the evaluation of different material systems for automotive exterior applications, there are currently no test methods available to measure and predict a viewer's (i.e., customer's) perception of such scratch severity. Therefore, it would be desirable to have systems, methods and/or models for quantifying (i.e., predicting) the visibility of a scratch on a polymer surface, such as scratches on the surface of automotive exterior components. It would be further desirable to have such systems, methods and/or models that would allow the relationship between the perceived visual quality of the scratches and the measurable optical properties associated therewith to be determined and modeled, thereby allowing such scratch visibility to customers to be predicted without needing to repeatedly survey to obtain such information.

No suitable systems, methods and/or models for predicting the human perception of the severity of a scratch on a polymer surface, such as scratches on the surface of automotive exterior components, currently exist. Furthermore, no suitable systems, methods and/or models that allow the relationship between the perceived visual quality of scratches and the measurable optical properties associated therewith to be determined and modeled currently exist either. For example, Wang et al. mentions the issue of assessing visual observation of scratches on automotive interior systems, but performs ranking tests that do not provide a continuous scale, which is needed to build functional forms for perception of scratch visibility in terms of measurable optical parameters. Kigle-Boeckler discusses the critical importance of the effects of color and gloss on paint appearance, but does not quantify human perception of these effects. Pourdeyhimi et al. recognizes the importance of appearance changes brought about by scratch and mar damage, but focuses on the measurement of appearance by image analysis, mentioning only that human perception assessments are laborious and difficult. Ferwerda et al. introduces a model of surface gloss perception, but does not address the effects of other optical attributes and their interactions. Finally, Mingolla et al. mentions perception of lightness of color in surface regions near or within glossy highlights, but the study is limited to this specific problem.

Before such predictive systems, methods and/or models can be created, customer perception first needs to be studied and quantified. Customer surveys provide one way of studying/evaluating customer perception for an item of interest. Customer surveys are commonly used to measure latent constructs, such as customer satisfaction, customer preference, or customer perception of an item of interest. Many surveys contain different types of errors (i.e., noise in the data) that endanger the reliability and validity of the results drawn from them. Thus, there is a need for survey methods that will better capture a survey respondent's assessments by allowing the surveyor to identify, model, and then eliminate if necessary, the different types of errors present in surveys.

There is specifically a need for a better way to assess a person's visual perception of surface irregularities, particularly scratches on a product (i.e., scratches on automotive exterior components). Traditionally, visual perception of such irregularities has been evaluated by providing survey respondents with a set of plaques, which the respondents then rank from best to worst. Although the information gained from such ranking is valuable, it does not, in itself, provide any interval scale information. For example, three samples could be ranked 1, 2 and 3, where 1is the best and 3 is the worst. However, this does not necessarily mean that the sample ranked 1 is three times better than the sample ranked 3. Thus, it would be desirable to have a rating scale, in addition to or in place of the ranking scale, where the survey respondents may assign an actual quantitative rating number to his or her perception. However, rating scales can yield a higher risk of error than do ranking scales. The errors associated with rating scales involve both response bias (i.e., reproducibility between respondents) and measurement errors (i.e., repeatability within a respondent). Thus, a rating scale that allows for an understanding of the visual perception, or other predetermined perception, without being overwhelmed by the errors associated therewith, is needed.

Alwin and Krosnick's, “The Measurement of Values in Surveys: A Comparison of Ratings and Rankings” mentions the issue of response bias when using rating scales, but does not address how to construct a rating scale to handle this response bias. Krosnick and Fabrigar's, “Designing Rating Scales for Effective Measurement in Surveys” discusses rating scales on a more discrete level (i.e., rating scales that range from 1 to 5 with possible verbal, rather than numeric, labels), but does not adequately address treatment of response bias and measurement errors for rating scales on a continuous level.

While it is desirable to have statistical methods for converting survey respondents' perceptions into numerical form, thereby quantifying people's perceptions, it would be further desirable to develop models' therefrom so that survey respondents' perceptions could be related to measurable properties, and so that survey respondents' perceptions as a function of those measurable properties could be predicted. Ideally, it would be desirable to have models that can predict what customers' perception of scratches on automotive parts will be. Once accurate models are created for predicting what survey respondents will perceive, the necessity of regularly and repeatedly surveying people will no longer be necessary. Such models may allow various measurements to be taken and input into the model(s), where the anticipated perceptions may then be output from, so that surveys will no longer need to be relied upon to acquire such information. This may lead to significant cost and time savings. Such survey systems, methods and models may be beneficial in numerous situations and applications.

There are presently no suitable systems, methods and/or models for predicting what customers' perception of an item of interest will be. Specifically, there are no suitable systems, methods and/or models for predicting what customers' perceptions of scratches on automotive parts will be. Thus, there is a need for such systems, methods and/or models. There is also a need to have such systems, methods and/or models that allow the relationship between the perceived visual quality of scratches and the measurable optical properties associated therewith to be determined and modeled, thereby allowing such scratch visibility to customers to be predicted without needing to repeatedly survey to obtain such information. There is yet a further need to have such systems, methods and/or models utilize two-step moving scale surveys so as to allow for the evaluation of response bias and/or measurement error in the survey data upon which the models are based. There is still another need to have survey systems and methods that utilize a two-step moving scale survey process for evaluating perception of any item of interest. Many other needs will also be met by this invention, as will become more apparent throughout the remainder of the disclosure that follows.

### SUMMARY OF THE INVENTION

Accordingly, the above-identified shortcomings of existing systems, methods and/or models are overcome by embodiments of the present invention, which relates to systems, methods and/or models for predicting what customers' perception of an item of interest will be. Embodiments of this invention comprise systems, methods and/or models for predicting what customers' perceptions of scratches on automotive parts will be. Many embodiments comprise systems, methods and/or models that allow the relationship between the perceived visual quality of scratches and the measurable optical properties associated therewith to be determined and modeled, thereby allowing such scratch visibility to customers to be predicted without needing to repeatedly survey to obtain such information. Many embodiments also utilize two-step moving scale surveys so as to allow for the evaluation of response bias and/or measurement error in the survey data upon which the models are built/designed. Finally, embodiments of this invention comprise survey systems and methods that utilize a two-step moving scale survey process for evaluating perception of any item of interest, not just for assessing customer perception of scratches on automotive components.

Embodiments of this invention begin with two-step moving scale survey systems and methods wherein a first set of control samples are presented to a survey respondent, and then a second set of survey samples are presented to the survey respondent. For each set of samples, the survey respondent is asked to assign a quantitative assessment value of their perception to each sample. Thereafter, the survey results may be analyzed and related to predetermined measurable properties, such as scratch size, sample color, sample gloss, and scratch scattering effect, and then a model may be created that relates the measurable properties to the survey results. Once such a model exists, surveys are no longer needed; the predetermined measurable properties may simply be measured, and the measurements may be input into the model, so the model can predict what the human perception assessments will be.

The control samples utilized in the first step of the survey preferably comprise at least one fixed pre-assessed sample that already has a quantitative assessment value assigned to it, and the survey respondents may not change this quantitative assessment value. The remaining control samples (called movable control samples) comprise control samples that will be rated (i.e., assigned a quantitative assessment value) by the survey respondents in the first step of the survey. The second step of the survey comprises a number of survey samples comprising samples of interest to the surveyor. Additionally, the survey samples also preferably comprise at least one of the movable control samples from the first step and a replicate of at least one of the survey samples from the second step. During the second step of the survey, the survey respondents may refer to the quantitative assessment values they assigned to each control sample in the first step while assigning quantitative assessment values to each survey sample (and any control samples from the first step that are also included here) in the second step, but they may not change the quantitative assessment values that they already assigned to each movable control sample in the first step of the survey. However, survey respondents may ultimately end up assigning different quantitative assessment values to the movable control samples in the second step than they assigned to those same movable control samples in the first step, whether knowingly or not.

Once the survey data is collected, it may be analyzed and models may be built that relate the survey results to the measurable properties, thereby eliminating the recurrent need to survey for such results. Such models may allow for significant cost and time savings.

Further features, aspects and advantages of the present invention will be more readily apparent to those skilled in the art during the course of the following description, wherein references are made to the accompanying figures which illustrate some preferred forms of the present invention, and wherein like characters of reference designate like parts throughout the drawings.

### DESCRIPTION OF THE DRAWINGS

The systems and methods of the present invention are described herein below with reference to various figures, in which:

FIG. 1 is a flowchart showing the steps that may be followed to create and/or utilize a predictive model in embodiments of this invention.

FIG. 2 is schematic diagram showing the rating scale utilized in one embodiment of this invention;

FIG. 3 is a graphical representation showing the relationship between the visual quality of a scratch and one of the measurable optical parameters (i.e., sample color) as determined in one embodiment of this invention; and

FIG. 4 is a graphical representation showing the relationships between the visual quality of a scratch and the physical dimensions of the scratch (i.e., the scratch width and the scratch depth) as determined in one embodiment of this invention.

### DETAILED DESCRIPTION OF THE INVENTION

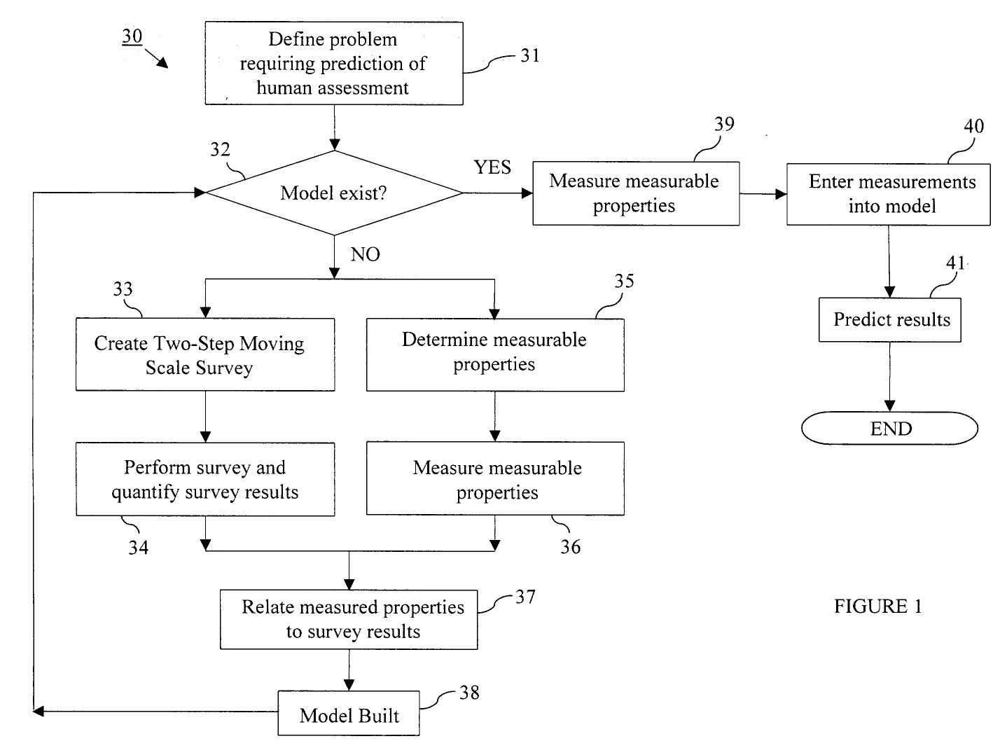

For the purposes of promoting an understanding of the invention, reference will now be made to some preferred embodiments of the present invention as illustrated in FIGS. 1-4, and specific language used to describe the same. The terminology used herein is for the purpose of description, not limitation. Specific structural and functional details disclosed herein are not to be interpreted as limiting, but merely as a basis for the claims as a representative basis for teaching one skilled in the art to variously employ the present invention. Any modifications or variations in the depicted systems, methods and models, and such further applications of the principles of the invention as illustrated herein, as would normally occur to one skilled in the art, are considered to be within the spirit of this invention.

The present invention comprises systems, methods and/or models for predicting what customers' perception of an item of interest will be. These systems, methods and/or models may be used for predicting what customers' perceptions of scratches on automotive parts will be. Embodiments of this invention may allow the relationship between the perceived visual quality of scratches and the measurable optical properties associated therewith to be determined and modeled, thereby allowing such scratch visibility to customers to be predicted without needing to repeatedly survey to obtain such information.

The present invention also comprises systems and methods that allow response bias and/or measurement errors in surveys to be evaluated, estimated and/or measured. These systems and methods are useful for creating and administering customer surveys, as well as for analyzing and quantifying the responses obtained from such surveys. It is known that using surveys to measure a latent construct, such as customer satisfaction or product preference, yields results having response biases and measurement errors associated therewith. Both response biases and measurement errors are essentially unavoidable, especially when human subjects are involved and survey methodology is utilized. However, the systems and methods of this invention drastically improve the quality of the data that is obtained from surveys, by allowing for better estimation of response bias and measurement error than is possible with existing systems and methods. Furthermore, once a sufficient number of people have been surveyed about a sufficient number of samples, and their responses have been analyzed, it is then possible to create a model that predicts the survey respondents' perceptions of the item of interest by utilizing related measurable properties thereof.

While models for predicting customers' visual perception of scratches on automotive exteriors will be explained in some examples herein, the various embodiments of this invention also have applicability to various other items of interest in various other fields. Therefore, no limitation to predicting the visual perception of automotive scratches is hereby intended.

As used herein, “response bias” may be described as the tendency of survey respondents to use the rating scale differently even if the measured latent construct level of one or more samples is the same. For example, for a satisfaction/dissatisfaction scale of from 1 to 5, two survey respondents with the same amount of satisfaction for a product may choose different quantitative ratings, or conversely, two survey respondents that rate their respective levels of satisfaction of the product as a 4 may actually have different satisfaction levels from each other. In short, what the ratings represent may change from one survey respondent to another. This is known as response bias.

As used herein, “measurement error” may be described as the discrepancy between the ratings and the true latent score due to the measurement used (i.e., due to the survey used). For example, if one is measuring the length of a product, the measurements from respondents may be different than the true length of the product due to the ruler being used (i.e., due to the varying increments printed on the rulers that allow respondents to be more or less accurate in their measurements). Similarly, the ratings on customer satisfaction, or any other latent construct being measured, can misrepresent the true score due to the survey that is being used.

Any suitable rating scale that allows enough space on the scale to differentiate between different items may be used in this invention. For example, embodiments of this invention comprise a rating scale ranging from 0 to 100, where 0 represents a plaque having no visible scratch at all on it, and 100 represents a plaque having a very visible and dramatic scratch on it. In one embodiment, scratches on painted steel samples were evaluated by survey respondents, while in another embodiment, scratches on a polymer surface were evaluated, and in yet another embodiment, scratches on painted steels and polymer surfaces were evaluated within the same survey. Any other type of surface irregularity on any other type of surface may also be evaluated, as can many other types of surface defects and/or anything else for which one desires to know survey respondents' perceptions for.

Embodiments of this invention preferably comprise a two-step moving scale rating process, so that response bias and measurement error can be measured, estimated and/or evaluated. First, survey respondents may be given a set of control samples to rate, some of which may be fixed pre-rated control samples and some of which may be movable control samples. Second, survey respondents may be given a set of survey samples to rate, wherein these survey samples may comprise one or more movable control samples from the first step. The survey respondent's ratings in both steps may be collected in any suitable manner, such as for example, on paper or via computer, or the like.

The control samples in the first step preferably comprise some fixed pre-rated control samples and some unrated, movable control samples for the survey respondents to rate. For example, the survey respondents may be presented with a control sample having no visible scratches on it that has been assigned a fixed rating of 0, and they may also be presented with a control sample having a severe scratch on it that has been assigned a fixed rating of 100. The survey respondents may then be asked to rate the remaining movable control samples on the 0-100 scale.

The survey samples in the second step preferably cover the range of variables that are being studied (i.e., in one particular embodiment, scratches of different widths, depths, etc.). In the second step, survey respondents may be given several unrated survey samples and be asked to rate them based on their perception of the scratches they see thereon. Preferably, some of the survey samples in this second step comprise one or more movable control samples from the first step, and also preferably comprise one or more replicates of the survey samples themselves. Survey respondents may be given the option of changing their ratings of the movable control samples in the second step, thereby creating a “moving scale” of their ratings. For example, in embodiments, while no changes may be made to the survey respondent's first step ratings, their first step ratings may be referenced by the survey respondent, and the survey respondent may rate a movable control sample differently in the second step than they did in the first step, whether knowingly or not.

Providing a two-step moving scale approach to measure the same latent construct (i.e., customer perception of surface scratches) allows response bias and measurement errors to be evaluated. Furthermore, the response bias can be modeled, if needed, by using transformations to put the ratings into interval scales. Additionally, by including replicates of the survey samples (which are not identified as such to the survey respondents) in the second step, measurement errors can also be estimated, and multivariate models, such as cluster analysis, may be used to identify the survey respondents having high measurement errors.

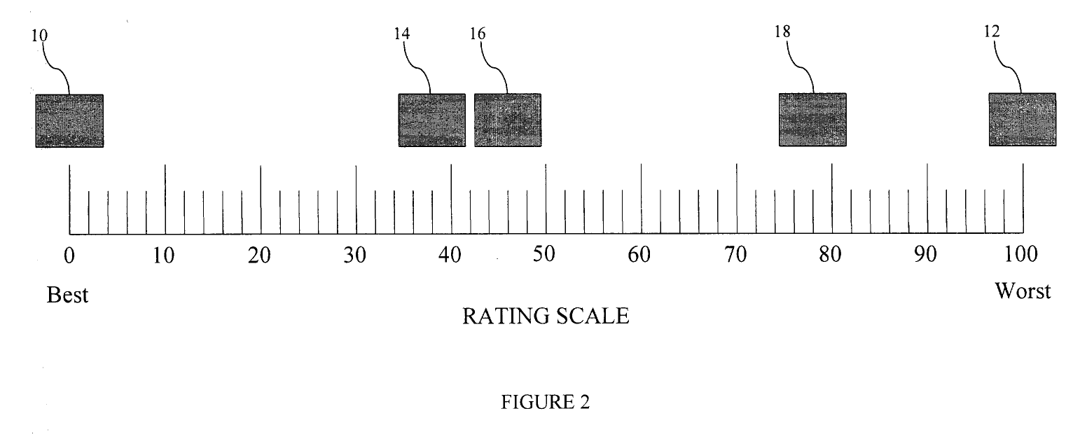

In one general embodiment of this invention, the rating scale may range from 0 to 100, with the first step comprising five control samples: 2 control samples having fixed ratings (i.e., 0 and 100), and 3 movable control samples which the survey respondents select a rating for. The second step may comprise 22 survey samples: 2 samples having fixed ratings (i.e., 0 and 100), 3 movable control samples from the first step which the survey respondents rate again, and 17 new samples (i.e., the survey samples) for which the survey respondent's visual perception is sought. Of these 17 new survey samples, preferably at least 3 are replicates of 3 different survey samples. Schematically, this first step is shown in FIG. 2, where one control sample 10 has a fixed rating of 0, another control sample 12 has a fixed rating of 100, and three additional movable control samples 14, 16, 18 are unrated control samples that the survey respondents will rate. This particular survey respondent gave movable control sample 14 a rating of 38, movable control sample 16 a rating of 46, and movable control sample 18 a rating of 78. Once the survey respondent's ratings are collected, the results may be analyzed, if desired, to determine the relationship, if any, that exists between the severity of the scratch perceived by the survey respondents and the measurable properties associated therewith.

In embodiments of this invention, a novel method to quantify the visibility of a scratch on a polymer surface (i.e., an automotive component) is disclosed. As noted before, aesthetic considerations are replacing rust and/or corrosion resistance as the primary concern for scratches on automotive components, especially as automotive manufacturers move away from metallic substrates for such components. Also as noted before, there are currently no test methods available to measure and predict a viewer's (i.e., customer's) perception of such scratch severity. Therefore, these embodiments were developed in response to the needs of the automotive industry. These embodiments allow the relationship between the perceived visual quality of scratches and the measurable optical and/or physical properties associated therewith to be determined and modeled, thereby allowing such scratch visibility to customers to be predicted without needing to repeatedly survey to obtain such information. Such predictions are critical when designing polymer systems for applications where aesthetics are important.

The visual appearance of a scratch can be quantified as a function of various optical parameters that define the visual contrast of the scratch and the surrounding area. The optical parameters that define the quality of any surface include its gloss, color, the size of the contrasting area, and the scattering effect associated with the scratch. The optical contrasts introduced by a scratch on a surface are, therefore, contrasts in gloss, color and scattering effect between the scratch and the surrounding area, as well as the size and sharpness of the contrasting area. Independent measurement of each relevant optical parameter (i.e., scratch size, color, gloss, scattering effect) is necessary in order to quantify the total optical contrast due to a scratch.

In embodiments, visual surveys (i.e., two-step moving scale surveys) were utilized to understand how the human eye combines a scratch and its surface optical attributes together to perceive the overall visual quality of the scratch. The effect of gloss, color, scratch size and other scattering effects were each surveyed independently for various materials. The dependence of visual perception on these optical properties/parameters and their interactions was studied for various scratches—ranging from shallow scratches to heavy fractures—on various materials. In these embodiments, survey respondents were given sets of samples comprising scratches of varying size and roughness inside the scratch (i.e., scattering effects) on different materials having varying gloss and color. Survey respondents were then asked to rate the severity of the scratches that they saw thereon (i.e., provide an estimated value for the visual quality of the scratches). After collecting and analyzing the survey responses, it was apparent that there were certain critical parameters that affected the human perception of scratch severity.

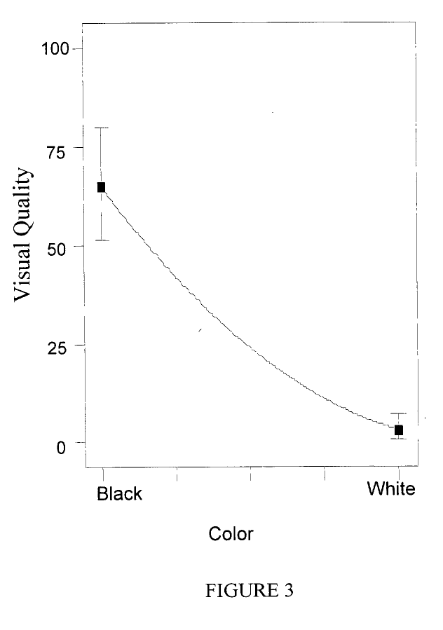

For example, for a smooth scratch, it was found that the scratch size and the sample color have strong effects on the perceived visual quality of a scratch. The visibility of such a scratch decreases with increasing “lightness” of color, which can be quantified so as to allow the visual quality of a scratch for any surface color (i.e., “lightness”) to be predicted. The effect that sample color has on perceived visual quality is non-linear, as shown in FIG. 3. The effect that scratch size has on perceived visual quality is linear until the onset of mechanisms such as fracture, cracking, etc., cause strong scattering effects, which then dominate the human perception of the visual quality of the scratch.

The gloss of the sample is also an important parameter, but mainly only for light, shallow scratches. A high gloss finish on a sample increases the visibility of light, shallow scratches.

Once the survey respondents' responses were collected and analyzed, scratch visibility as a function of the optically measurable properties (i.e., sample gloss, sample color, scratch size, and scratch scattering effects in this embodiment) could be determined, and a model for predicting the anticipated visual perception of the scratches could be created.

In one embodiment, the visual quality of a given scratch may be predicted by measuring the measurable optical parameters thereof and inputting the values therefor into a model, wherein the model utilizes the following equation:

$$Sqrt ( Visual Quality ) = - 4.08349 - {1.29683}^{- 5} * C + 0.4142 * SZ + {3.75675}^{- 5} * G + {5.18107}^{- 3} * SC - {2.68025}^{- 3} * {SZ}^{2} - {1.44123}^{- 7} * C * SZ + {1.30325}^{- 10} * C * G - {3.20923}^{- 8} * C * SC - {1.17438}^{- 6} * SZ * G$$

where C=color of the sample, SZ=scratch size, G=gloss of the sample, and SC=scattering effect (in pixel units). These optically measurable parameters may be measured using the optical imaging equipment described in co-pending, commonly-owned U.S. patent application Ser. No. 09/617,972, filed Oct. 18, 2000, entitled “Method of Objectively Evaluating a Surface Mark,” which is hereby incorporated in full by reference. The optical imaging test hardware comprises a collimated source of white light and two telecentric lenses and camera systems. A first camera system measures the specularly reflected light and captures an image thereof. This first image may then be analyzed to obtain values for the gloss of the sample (G), and the scratch size (SZ). The effects of color and scattering from inside the scratch are not detected by the first camera system, thereby allowing independent measurements of off-specular scattering to be made. The second camera system, located at an off-specular angle, measures the diffusely scattered light and captures an image thereof. This second image may then be analyzed to obtain values for the color of the sample (C) and the scattering effect from inside the scratch (SC). Each of these values for the optically measured parameters may then be input into the equation above to predict what the anticipated scratch visibility will be. This equation is capable of predicting scratch visibility for scratches on a variety of different thermoplastics and painted steel systems, with scratch sizes ranging from light carwash-type scratches to heavy fractures. Additionally, the equation may be utilized for sample colors ranging from black to white, for sample gloss on materials having a 60-degree gloss of about 85-120, and for scattering effects arising from different modes of failure such as stress-whitening, cracking or fracture.

The models described above quantify: (a) the effects of the size, gloss, color, and scattering effects of a scratch on human perception; and (b) the interaction between the size, gloss, color and scattering effects of a scratch that result in the overall perceived visual quality/appearance of the scratch. These models may be used to study the effect of any of these optically-measurable parameters, either individually or collectively. For example, these models may be used to predict what the perceived size of a scratch will be. These models could also be used to predict what effect a change in the glossiness of the surface, a change in the color of the surface, and/or a change in the roughness inside the scratch (i.e., the cavitation or fracture effects of the scratch) will have on scratch perception.

In another embodiment, the appearance of a scratch as perceived by the eye was defined as a function of the physical dimensions of the scratch. The actual physical dimensions of the scratches (i.e., total scratch depth and peak-to-peak scratch width) were measured using an optical profilometer. The appearance of a scratch as a function of these varying physical parameters was then quantified, and a model was developed for predicting the human perception of scratches based on these physical scratch properties. The visual quality of a scratch may be calculated via a model comprising the following equation:

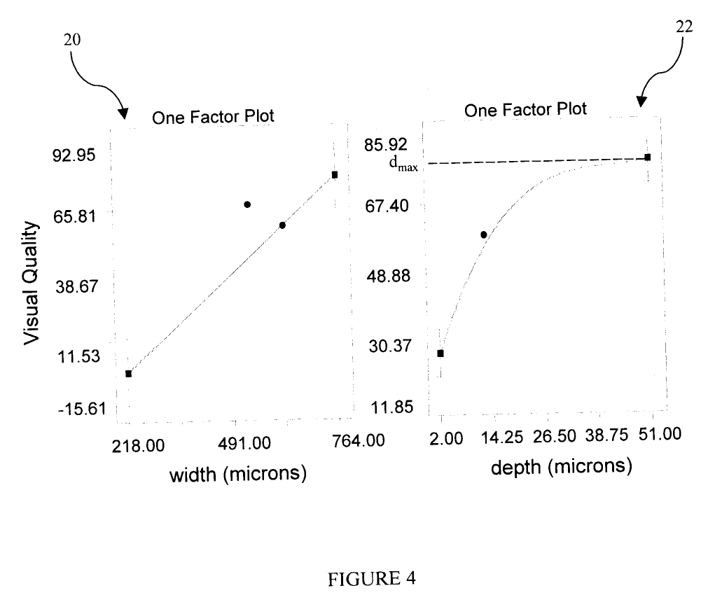

Visual Quality=48.9−0.2*d+24.1*w−21.0*d²+(16.6*d*w)+10.8*d³

where d=actual total depth of the scratch (microns), and w=actual peak-to-peak width of the scratch (microns). In these embodiments, survey respondents were given a set of samples comprising scratches of varying depths and widths on various different materials, and were asked to rate the visual quality of the scratch that they observed. After collecting and analyzing the survey responses, it was apparent that width perception displayed a strong linear effect 20, but that depth perception displayed a non-linear effect 22, as shown in FIG. 4. In this embodiment, survey respondents appeared to be more sensitive to changes in depth for shallow scratches, with decreasing sensitivity to changes in scratch depth until there were no longer any perceived differences in scratch depth beyond a certain depth, dₘₐₓ (dₘₐₓ is a function of the scratch width and was approximately 76-77 microns in this example). From the data collected about the survey respondents' assessments of the scratches, scratch visibility as a function of the physically measurable properties (i.e., scratch depth and scratch width in this embodiment) was determined, and a model for predicting the anticipated visual perception of scratches was created. Thereafter, models were developed to predict the appearance of a scratch on any material containing similar scratches.

It will be apparent to those skilled in the art that numerous other mathematical equations and/or models could be created to allow the perception of a scratch on a material to be predicted, and all such variations, including both linear and non-linear transformations of the response and/or input parameters, are deemed to be within the scope of this invention. Furthermore, different models could be created that would allow the perception of various other items of interest to be predicted, and these too are deemed to be within the scope of this invention. Finally, the two-step moving scale surveys discussed herein could be utilized in numerous types of surveys, and all such surveys are deemed to be within the scope of this invention.

The models described above provide methods for evaluating scratches in a manner that matches human observation, but without the inherent physical and psychological consistency problems that go along with using human observers or respondents to evaluate scratch severity.

A flowchart 30 showing the steps that may be followed to create and/or utilize a two-step moving scale survey to create a predictive model, as utilized in embodiments of this invention, is shown in FIG. 1. First, a surveyor may define a problem that requires predicting the human assessment thereof 31. Next, the surveyor should query whether or not an applicable model already exists 32 for that particular circumstance.

If a model for that particular circumstance does not exist, then the surveyor may create a two-step moving scale survey 33 that can be used to collect data (i.e., customer perception) on items of interest. Thereafter, the surveyor may actually perform the two-step moving scale survey to collect the data and quantify the results thereof 34. While the survey is being created and performed, the related measurable properties may be determined 35 simultaneously therewith, and these measurable properties may actually be measured 36. Thereafter, the survey results may then be analyzed, and be related to measurable/measured related properties 37. Thereafter, a model may be created 38 to predict the survey results. Once the model is created, instead of surveying for human perception of an item of interest, the measurable related properties may simply be measured 39, the measured values may be entered into the model 40, and the human perception assessments of that circumstance may then be predicted by the model 41.

If a model for a particular problem already exists, then the surveyor can proceed directly to measuring the measurable related properties 39 for that particular circumstance. Thereafter, the measured values may be entered into the model 40, and the human perception assessments of that circumstance may be predicted by the model 41.

As described above, the systems, methods and models of this invention may be utilized to predict human perception of items of interest, so that perceptions/assessments of various items of interest may be predicted without requiring recurrent surveying. Specifically, these systems, methods and models may be utilized to predict customer perception of scratches on automotive components. Additionally, the two-step moving scale survey systems and methods of the present invention allow response bias and measurement error in various surveys to be evaluated.

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

What is claimed is:

1. A two-step moving scale survey method for evaluating response bias and measurement error in surveys, the method comprising:
providing a set of control samples to a survey respondent in a first survey step;
providing a set of survey samples to the survey respondent in a second survey step;
obtaining a quantitative assessment value for each control sample and each survey sample from the survey respondent.

2. The method of claim 1, further comprising:
analyzing the quantitative assessment values.

3. The method of claim 2, further comprising:
relating the quantitative assessment values to predetermined measurable properties.

4. The method of claim 3, further comprising:
creating a model to predict the quantitative assessment values.

5. The method of claim 4, further comprising:
measuring the predetermined measurable properties.

6. The method of claim 5, further comprising:
utilizing the model and the measurements of the predetermined measurable properties to predict the quantitative assessment values.

7. The method of claim 1, wherein the set of control samples utilized in the first survey step comprises: (a) at least one fixed pre-assessed sample that already has a quantitative assessment value assigned to it, which the survey respondent may not change; and (b) at least one movable control sample which the survey respondent will assign a quantitative assessment value to.

8. The method of claim 7, wherein the set of survey samples utilized in the second survey step comprises at least one of the movable control samples that was utilized in the first survey step.

9. The method of claim 1, wherein the survey respondent may refer to the quantitative assessment values they assigned to each control sample in the first survey step while assigning quantitative assessment values to each survey sample in the second survey step.

10. The method of claim 9, wherein the survey respondent may not change the quantitative assessment values that they already assigned to each control sample in the first survey step while assigning quantitative assessment values to each survey sample in the second survey step.

11. The method of claim 10, wherein the survey respondent may assign a quantitative assessment value to a control sample in the first survey step then assign a different quantitative assessment value to the same control sample in the second survey step.

12. The method of claim 1, wherein the control samples and the survey samples comprise an automotive exterior component comprising surface irregularities thereon.

13. The method of claim 3, wherein the predetermined measurable properties comprise at least one of: scratch size, sample color, sample gloss, and scratch scattering effect.

14. The method of claim 4, wherein the model is capable of predicting a visual quality rating for a variety of scratches on a variety of materials via the following equation:
$$Sqrt ( Visual Quality ) = - 4.08349 - {1.29683}^{- 5} * C + 0.4142 * SZ + {3.75675}^{- 5} * G + {5.18107}^{- 3} * SC - {2.68025}^{- 3} * {SZ}^{2} - {1.44123}^{- 7} * C * SZ + {1.30325}^{- 10} * C * G - {3.20923}^{- 8} * C * SC - {1.17438}^{- 6} * SZ * G$$
where C=color of the sample, SZ=scratch size, G=gloss of the sample, and SC=scattering effect (in pixel units).

15. The method of claim 4, wherein the model is capable of predicting a visual quality rating for a variety of scratches on a variety of materials via the following equation:
Visual Quality=48.9−0.2*d+24.1*w−21.0*d²+(16.6*d*w)+10.8*d³
where d=actual total depth of the scratch (microns), and w=actual peak-to-peak width of the scratch (microns).

16. A method utilizing a two-step moving scale survey to create a predictive model, the method comprising:
creating a two-step moving scale survey capable of being utilized to collect quantitative survey data about an item of interest;
performing the two-step moving scale survey to collect the quantitative survey data about the item of interest;
determining at least one related measurable property that is associated with the item of interest;
measuring the at least one related measurable property that is associated with the item of interest;
relating the quantitative survey data about the item of interest obtained from the two-step moving scale survey to the measurement of the at least one related measurable property; and
creating a model to predict the results of the two-step moving scale survey.

17. The method of claim 16, wherein the item of interest comprises surface irregularities on an automotive exterior component.

18. The method of claim 16, wherein the at least one predetermined measurable related property comprises at least one of: scratch size, sample color, sample gloss, and scratch scattering effect.

19. The method of claim 16, wherein the model is capable of predicting a visual quality rating for a variety of scratches on a variety of materials via the following equation:
$$Sqrt ( Visual Quality ) = - 4.08349 - {1.29683}^{- 5} * C + 0.4142 * SZ + {3.75675}^{- 5} * G + {5.18107}^{- 3} * SC - {2.68025}^{- 3} * {SZ}^{2} - {1.44123}^{- 7} * C * SZ + {1.30325}^{- 10} * C * G - {3.20923}^{- 8} * C * SC - {1.17438}^{- 6} * SZ * G$$
where C=color of the sample, SZ=scratch size, G=gloss of the sample, and SC=scattering effect (in pixel units).

20. The method of claim 16, wherein the model is capable of predicting a visual quality rating for a variety of scratches on a variety of materials via the following equation:
Visual Quality=48.9−0.2*d+24.1*w−21.0*d²+(16.6*d*w)+10.8*d³
where d=actual total depth of the scratch (microns), and w=actual peak-to-peak width of the scratch (microns).

21. A two-step moving scale survey system capable of allowing response bias and measurement error in surveys to be evaluated, the system comprising:
a means for creating a two-step moving scale survey capable of being utilized to collect quantitative survey data about an item of interest;
a means for performing the two-step moving scale survey to collect the quantitative survey data about the item of interest;
a means for determining at least one related measurable properties that is associated with the item of interest;
a means for measuring the at least one related measurable property that is associated with the item of interest relating the results of the performed two-step moving scale survey to at least one predetermined measurable related property;
a means for relating the quantitative survey data about the item of interest obtained from the two-step moving scale survey to the measurement of the at least one related measurable property; and
a means for creating a model to predict the results of the two-step moving scale survey.

22. The system of claim 21, wherein the item of interest comprises surface irregularities on an automotive exterior component.

23. The system of claim 21, wherein the at least one predetermined measurable related property comprises at least one of: scratch size, sample color, sample gloss, and scratch scattering effect.

24. The system of claim 21, wherein the model is capable of predicting a visual quality rating for a variety of scratches on a variety of materials via the following equation:
$$Sqrt ( Visual Quality ) = - 4.08349 - {1.29683}^{- 5} * C + 0.4142 * SZ + {3.75675}^{- 5} * G + {5.18107}^{- 3} * SC - {2.68025}^{- 3} * {SZ}^{2} - {1.44123}^{- 7} * C * SZ + {1.30325}^{- 10} * C * G - {3.20923}^{- 8} * C * SC - {1.17438}^{- 6} * SZ * G$$
where C=color of the sample, SZ=scratch size, G=gloss of the sample, and SC=scattering effect (in pixel units).

25. The method of claim 21, wherein the model is capable of predicting a visual quality rating for a variety of scratches on a variety of materials via the following equation:
Visual Quality=48.9−0.2*d+24.1*w−21.0*d²+(16.6*d*w)+10.8*d³
where d=actual total depth of the scratch (microns), and w=actual peak-to-peak width of the scratch (microns).

26. A method for predicting human perception of an item of interest, the method comprising:
determining a relationship between perceived properties of the item of interest and predetermined measurable properties associated with the item of interest;
creating a model that defines the relationship between the perceived properties of the item of interest and the predetermined measurable properties associated with the item of interest;
measuring the predetermined measurable properties associated with the item of interest; and
utilizing the model and the measurements of the predetermined measurable properties associated with the item of interest to predict the human perception of the item of interest.

27. The method of claim 26, wherein the determining step comprises utilizing a two-step moving scale survey to determine the relationship between the perceived properties of the item of interest and the predetermined measurable properties associated with the item of interest.

28. The method of claim 26, wherein the item of interest comprises at least one scratch on a material.

29. The method of claim 28, wherein the material comprises a material utilized for automotive components.

30. The method of claim 29, wherein the material comprises a material utilized for an automotive component.

31. The method of claim 26, wherein the predetermined measurable properties associated with the item of interest comprises at least one of: scratch size, sample color, sample gloss, and scratch scattering effect.

32. The method of claim 26, wherein the model comprises the equation:
$$Sqrt ( Visual Quality ) = - 4.08349 - {1.29683}^{- 5} * C + 0.4142 * SZ + {3.75675}^{- 5} * G + {5.18107}^{- 3} * SC - {2.68025}^{- 3} * {SZ}^{2} - {1.44123}^{- 7} * C * SZ + {1.30325}^{- 10} * C * G - {3.20923}^{- 8} * C * SC - {1.17438}^{- 6} * SZ * G$$
where C=color of the sample, SZ=scratch size, G=gloss of the sample, and SC=scattering effect (in pixel units).

33. The method of claim 26, wherein the model is capable of predicting a visual quality rating for a variety of scratches on a variety of materials via the following equation:
Visual Quality=48.9−0.2*d+24.1*w−21.0*d²+(16.6*d*w)+10.8*d³
where d=actual total depth of the scratch (microns), and w=actual peak-to-peak width of the scratch (microns).

34. A method for predicting human perception of one or more scratches on an automotive component, the method comprising:
determining a relationship between physical scratch properties and measurable optical properties associated with the scratches;
creating a model that defines the relationship between the physical scratch properties and the measurable optical properties associated with the scratches;
measuring the measurable optical properties associated with the scratches;
utilizing the model and the measurements of the measurable optical properties to predict the human perception of the scratches.

35. The method of claim 34, wherein the determining step comprises utilizing a two-step moving scale survey to determine the relationship between the physical scratch properties and the measurable optical properties associated with the scratches.

36. The method of claim 34, wherein the measurable optical properties associated with the scratches comprises at least one of: scratch size, sample color, sample gloss, and scratch scattering effect.

37. The method of claim 34, wherein the model comprises the equation:
$$Sqrt ( Visual Quality ) = - 4.08349 - {1.29683}^{- 5} * C + 0.4142 * SZ + {3.75675}^{- 5} * G + {5.18107}^{- 3} * SC - {2.68025}^{- 3} * {SZ}^{2} - {1.44123}^{- 7} * C * SZ + {1.30325}^{- 10} * C * G - {3.20923}^{- 8} * C * SC - {1.17438}^{- 6} * SZ * G$$
where C=color of the sample, SZ=scratch size, G=gloss of the sample, and SC=scattering effect (in pixel units).

38. The method of claim 34, wherein the model is capable of predicting a visual quality rating for a variety of scratches on a variety of materials via the following equation:
Visual Quality=48.9−0.2*d+24.1*w−21.0*d²+(16.6*d*w)+10.8*d³
where d=actual total depth of the scratch (microns), and w=actual peak-to-peak width of the scratch (microns).

39. A method of predicting human perception of an item of interest, the method comprising:
defining an item of interest that requires predicting human perception thereof;
identifying a model capable of predicting the human perception of the item of interest;
measuring predetermined measurable properties associated with the human perception of the item of interest;
entering the measurements of the predetermined measurable properties into the model; and
allowing the model to predict the human perception of the item of interest.
